(19) United States
(12) Patent Application Publication
(10) Pub. No.: US 2011/0082591 A1
(43) Pub. Date: Apr. 7, 2011

(54) REMOTE MANAGEMENT OF STORAGE FACILITIES

(75) Inventors: Joel Micka, Kennewick, WA (US); Bruce Johnson, Kennewick, WA (US); Mark Decker, Kennewick, WA (US); Robert Drozdowski, Richland, WA (US); Monte Carver, Kennewick, WA (US)

(73) Assignee: JMC Enterprises, Inc., Kennewick, WA (US)

(21) Appl. No.: 12/859,759

(22) Filed: Aug. 19, 2010

Related U.S. Application Data
(60) Provisional application No. 61/235,663, filed on Aug. 20, 2009.

(51) Int. Cl. G05D 23/00

(52) U.S. Cl. 700/276

(57) ABSTRACT

Systems and methods for remote management of storage facilities are disclosed herein. One aspect of the invention is directed toward a central management system including a server, and several managed facilities. Each facility is operated by at least one programmable logic controller (PLC), which gathers data regarding the operation of the facility and stores the data locally at the facility or sends the data back to the server. The server is configured to respond to requests from known web browsers to provide near real-time information to users concerning the storage facility.

### CROSS-REFERENCE TO RELATED APPLICATION(S)

The present application claims priority to and incorporates by reference in its entirely U.S. Provisional Patent Application No. 61/235,663 entitled “REMOTE MANAGEMENT OF STORAGE FACILITIES” filed Aug. 20, 2009.

### TECHNICAL FIELD

Embodiments of the present invention relate to remote management and control of storage facilities, such as agricultural storage facilities for fruits, vegetables, and other things.

### BACKGROUND

Warehouses and other storage facilities are typically designed to house and protect goods and merchandise from unauthorized access and weather. Some operations, such as large-scale agricultural operations, store relatively delicate goods such as produce. Fruits and vegetables, such as potatoes, are sensitive to environmental conditions such as temperature, humidity, lighting, particulate matter in the air, air quality, etc. These variables are typically controlled to maintain fresh produce. Some storage facilities depend on these interior characteristics to help the produce ripen even after harvested. Other, non-perishable goods may not be as sensitive to conditions, but most goods require some degree of supervision and control.

As farming and manufacturing operations increase in scale and expand across multiple, remote geographic locations, the task of managing each storage site becomes challenging. Security from human interference is also difficult to monitor when valuable goods are stored in many, dispersed locations. Also, maintaining a diverse supply of goods in different storage facilities requires qualified personnel to control and monitor the various goods in each facility.

To address some of these challenges, many storage facilities use computerized control equipment. Fans, windows, doors, cooling/heating equipment, and humidity controls are some examples of equipment that can affect and/or control the interior conditions of a storage facility. Combined with sensors that detect conditions within the facility, computerized equipment and control methods can provide better control of interior conditions than previously attained through, for example, manual control. However, managing and operating this diverse and complex equipment can be difficult. Some approaches have used workstations at each facility, but unifying the workstations, for example to update software, can become a daunting task as the number of workstations and storage locations grows. Accordingly, there is a need for a system that addresses these difficulties.

### BRIEF DESCRIPTION OF THE DRAWINGS

FIG. 1 is a schematic illustration of a central remote management system configured in accordance with an embodiment of the disclosure;

FIG. 2 is a schematic diagram of a remote management system configured in accordance with an embodiment of the disclosure;

FIG. 3 is a screen shot of a portion of a user interface configured in accordance with an embodiment of the disclosure;

FIG. 4 is a screen shot of a portion of a user interface configured in accordance with another embodiment of the disclosure;

FIG. 5 is a screen shot of a portion of a user interface configured in accordance with a further embodiment of the disclosure;

FIG. 6 is a screen shot of a portion of a user interface configured in accordance with another embodiment of the disclosure; and

Appendix A contains several screen shots of various portions of a user interfaces configured in accordance with embodiments of the disclosure.

### DETAILED DESCRIPTION

Aspects of the present disclosure are directed generally toward a centrally-operated remote management system configured to communicate with equipment at a plurality of remotely located storage facilities. According to one embodiment, a central server is configured to communicate with equipment at a remote storage site such as a panel and/or a programmable logic controller (PLC). The panel is configured to communicate with the PLC and through the panel, the server can receive data regarding operation of the PLC and other aspects of the storage site. The PLC contains the logic for operation of the storage site. In an embodiment, the PLC is configured to control the temperature, HVAC, humidity, and other aspects of the storage facility environment. The PLC can be operably connected to several sensors located throughout the storage facility, which can provide information to the PLC regarding virtually any measurable parameter in the storage facility environment. The PLC can be configured with control logic to maintain these parameters at acceptable levels to preserve and protect the goods, produce, or other items stored in the storage facility. The panel can be configured with a data storage device such as a hard drive, flash memory, or the equivalent. The PLC can periodically send data from the sensors and from control routines to the panel to store the data for later access.

According to some embodiments, the central server can be configured as a web server capable of receiving and responding to requests from web browsers. A user at a computer using a web browser (virtually any known browser can be used) can access the information and manipulate variables to control aspects of the storage facility environment. Alerts can be arranged to notify a user of an event at the storage facility, such as a temperature increase or a machine failure. A server administrator can designate permissions for users to grant, revoke, or limit access to the data.

Various embodiments of the disclosure are described below. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

References throughout the specification to “one embodiment” or “an embodiment” mean a particular feature, structure, or characteristic described in connection with the embodiment and included in at least one embodiment of the present invention. Thus, the appearances of the phrase “in one embodiment” or “in an embodiment” in various places throughout the specification are not necessarily all referring to the same embodiment. Furthermore, the particular features, structures, or characteristics may be combined in any suitable manner in one or more embodiments.

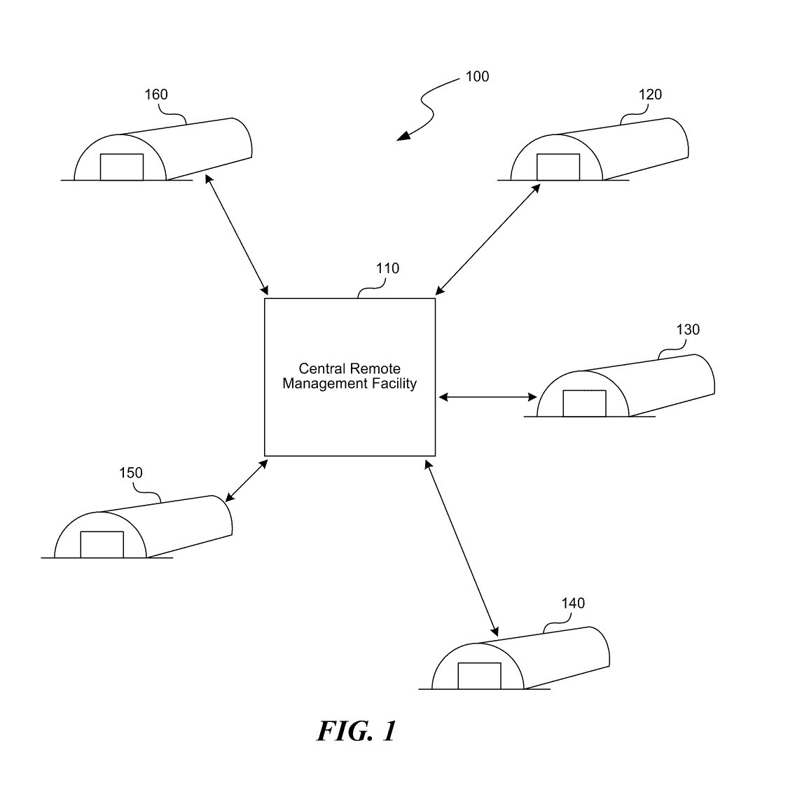

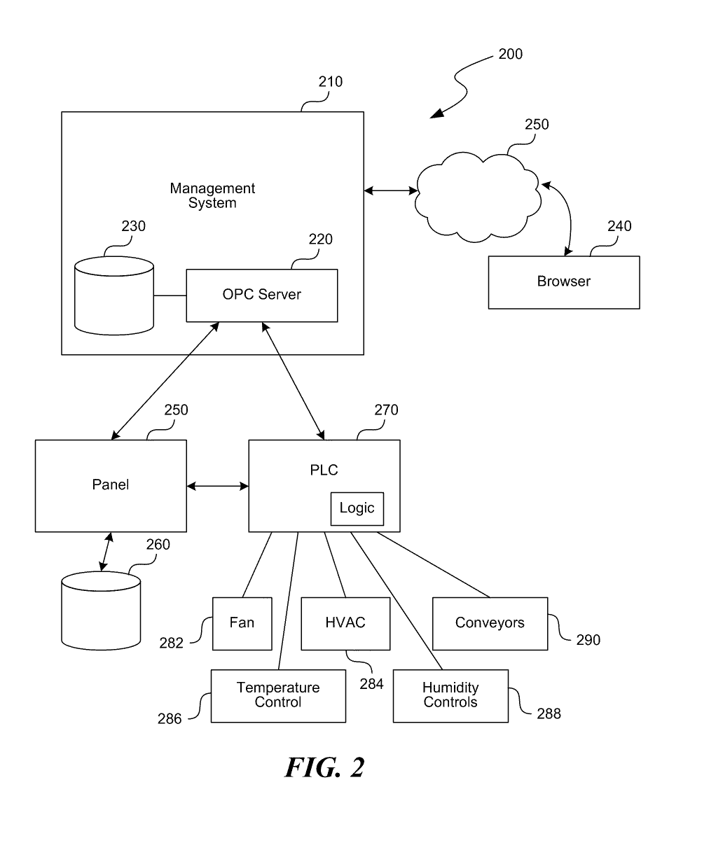

FIG. 1 illustrates a schematic overview of a centrally-operated remote management system 100 according to several embodiments of the present disclosure. A central remote-management facility 110 is configured to communicate with several remote facilities, such as storage facilities 120, 130, 140, 150, and 160. A more detailed description of the operation of both the remote and central facilities is given below with reference to FIG. 2. Each remote facility can be equipped with communication equipment such as an FTP server, or other equivalent communication means to send and receive data and instructions to the central facility 110.

It is to be appreciated that the facilities 120, 130, 140, 150, and 160 are used for illustrative purposes, and that the management system 100 can include any number of facilities. The facilities may not all be located remotely; some facilities can be near, adjacent to, or even housed within the same structure as the central management system 110. Also, a system 100 may comprise more than one centrally-operated management system 110. Any of the several systems 110 can service all or part of the facilities that make up the system 100.

FIG. 2 illustrates a remote management system 200 according to several embodiments of the present disclosure. A management system 210 comprises a server 220. In some embodiments, the server 220 comprises an OPC server. The server can be configured to operate a database 230. In one embodiment, the database 230 can be a central database. The server 220 can operate the database 230 by using software such as Firebird or the equivalent. It is to be appreciated that variations on the hardware and/or software configurations are intended to be within the scope of this disclosure, and that the systems and methods disclosed are not limited to a specific arrangement disclosed. For example, the server can be an OPC server, but one of ordinary skill in the art will appreciate that alternatives to an OPC server (such as custom-written drivers, etc.) are also available and are within the scope of this disclosure. The management system 210 is configured to communicate with a web browser 240 over a network 242 through a LAN, a WAN, over the Internet, or other network system. The web browser 240 can be any known browser such as Microsoft Internet Explorer, Mozilla Firefox, Apple Safari, Google Chrome, Netscape Navigator, or any other equivalent web browser. Because web browsers are ubiquitous, well-known, and versatile, the management system 210 does not require users to install or manage any proprietary software. Any computing station, laptop computer, desktop computer, or even mobile computing device can access information using a web browser.

In some embodiments the server 220 is configured to communicate with a panel 250 that can be located in a storage facility 201. The panel 250 can provide an interface between the server 220, a local database 260, and a PLC 270. In other embodiments, the server 220 can be configured to communicate directly with the PLC 270 in addition to the panel 250. The panel 250 can record data into the local database 260 as frequently as once per second to enable near real-time monitoring of the storage facility. The data is stored in the local database 260 and can be recalled by the server at anytime. When the local database storage 260 reaches its capacity, data can be archived back to the server 220 or discarded.

Several embodiments of the disclosure include a PLC 270 which contains the logic 280 to govern operation of a facility. For example, in an agricultural produce storage facility the temperature, humidity, and air circulation rate of a facility may be monitored and/or controlled. The PLC can communicate with a fan 282 to increase fan speed, decrease fan speed, or otherwise control the operation of the fan 282. Temperature sensors, such as thermometers, can be used to provide feedback to the PLC. Similarly, HVAC 284, temperature controls 286 and humidity controls 288 can also be monitored and controlled. In some embodiments, each system is accompanied by appropriate sensors for feedback to the PLC. In addition to these systems, any other measurable variable or parameter can be sensed and controlled in a similar manner. For example, conveyors 290 may be employed to move goods, produce, or other objects from place to place within the facility, or to move the goods out of the facility such as onto a truck for delivery. The status and operation of these systems can also be monitored and controlled through the PLC 270. The data describing these operations can be transmitted to the panel 250 and stored locally on the local database 260, from which the data can be accessed by the server and ultimately by a user on a web browser 240.

In some embodiments, the management system 210 is configured with software such as Delphi's intraweb software which maintains the state of the web page on the server, as opposed to on the client. This means that the calculations regarding the display, the format, and many other aspects of the web page are calculated on the server, rather than on the client. Doing so makes the website respond to requests much more quickly than conventional web pages. For the application according to some embodiments of the present disclosure, where large amounts of data are pulled from many sensors and actuators and other equipment from different, remote facilities and displayed in near real-time, calculating the web page on the server speeds up what could otherwise be a very slow process. In addition, the management system 210 can be distributed to customers, and the customers cannot easily duplicate the system and sell it to other parties. Web-based programs that are calculated on the client side are much more easily reverse-engineered and thus unauthorized copies can be easily made. Reducing the likelihood that the product will be reverse-engineered removes the need for other security such as digital right management (DRM) or tying use of the software to a particular piece of hardware (e.g., through an IP address, or MAC address, etc.).

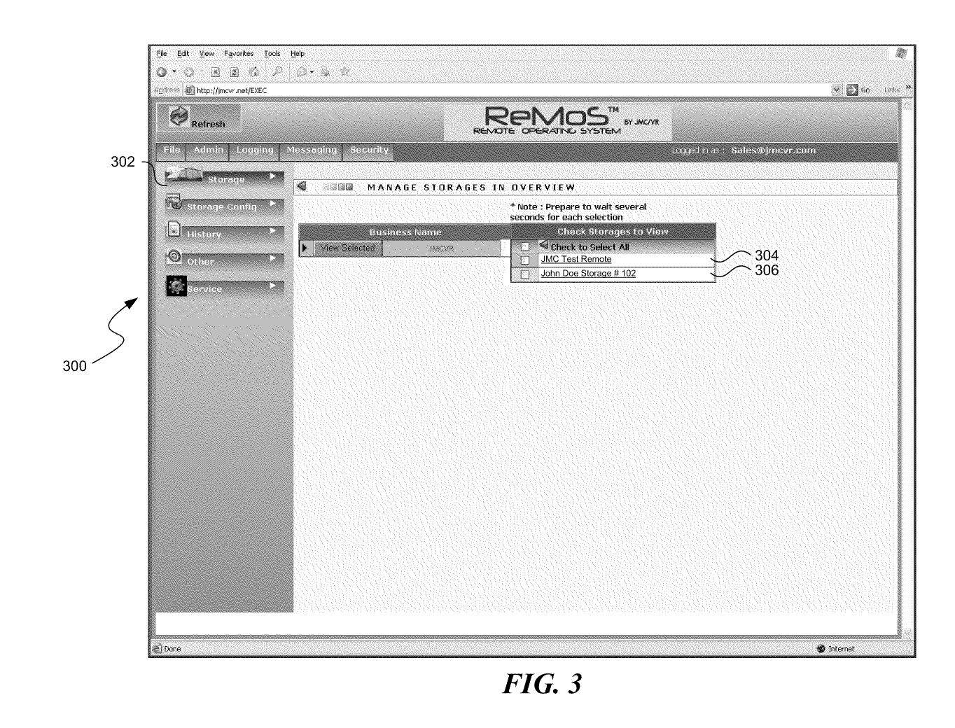

FIG. 3 is a screen shot of a graphical user interface 300 for a remote facility management system according to several embodiments of the present disclosure. An administrator can manage multiple users' access to the data stored on a server. There is virtually no limit to how a user's account privileges can be configured. The following description explains aspects of the user interface 300 from the perspective of a user assigned access to certain data regarding certain storage facilities. Storage menu 302 provides a list of storage facilities available to a user. In this example, the user can access two facilities, “JMC test remote,” 304 and “John Doe farms” 306.

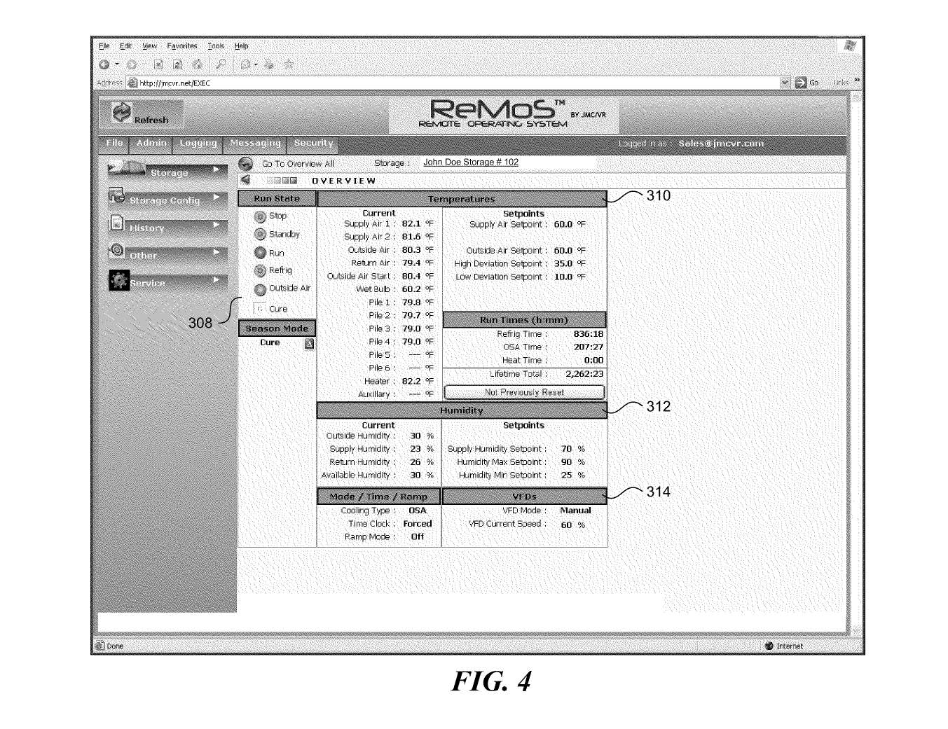

Selecting John Doe farms 306 brings up the screen shot depicted in FIG. 4, showing an overview of the storage facility #102. Panel 308 illustrates the run state of the facility, and shows buttons of different colors (e.g., red, yellow, green, etc) to convey the status of the storage facility (e.g., stop, standby, run, etc.), and to give the user the ability to manage the facility by clicking one or more of the buttons. Panel 310 illustrates several temperature “set points” of air flows and different piles of goods or produce, such as potatoes. Panel 312 similarly conveys information about the humidity in the facility. Panel 314 shows the status of variable frequency drives (VFDs) (e.g., mode, speed, etc.). Currently, the drives are operating at 60%. As described above, the data reflected in this interface 300 can be real time or near real time data. In some embodiments the PLC 270 sends data to the panel 250 as frequently as once per second or more, providing the user with accurate, current information about the facility. In other embodiments, the data is only captured and transmitted upon request by the user. Or, data may be updated every second while a web browser session is active, but otherwise no data is recorded.

In still further embodiments, the OPC server 220 can use an OPC client engine 221 to constantly or periodically retrieve nearly real-time data from the local database 260 for storage in the central database 230. In this embodiment, the OPC server 220 provides the browser 240 with current data from the database 230 without requiring a new and separate connection to each PLC 270. Many different combinations are possible, and can be selected depending on the purpose of the facility and the goods stored inside. A very sensitive product such as fresh fruit or vegetables, for example, may be monitored more closely than canned goods.

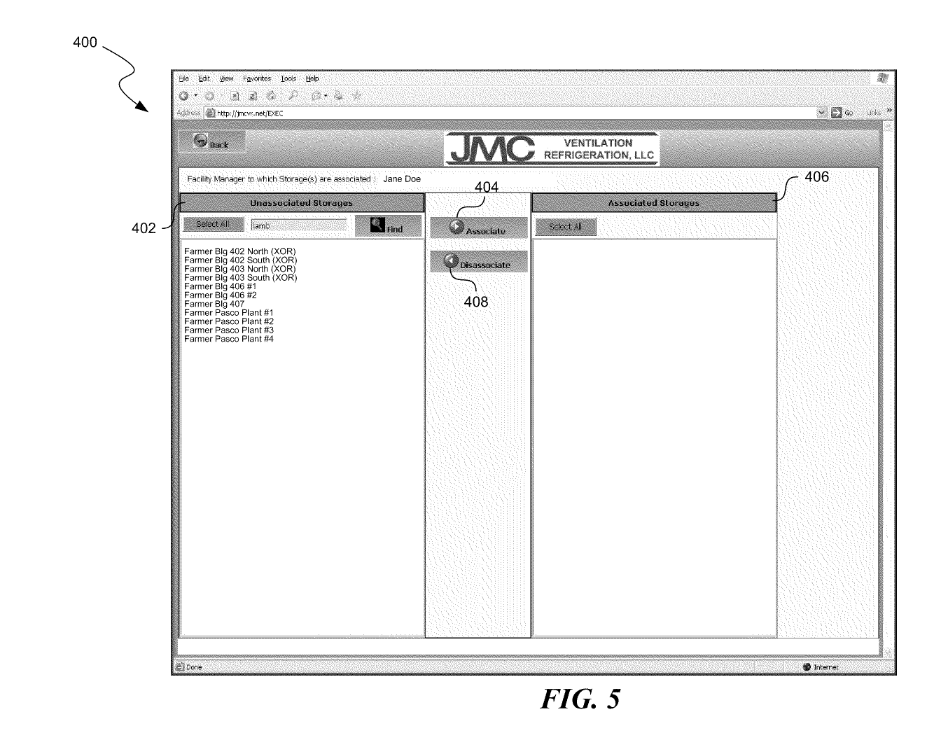

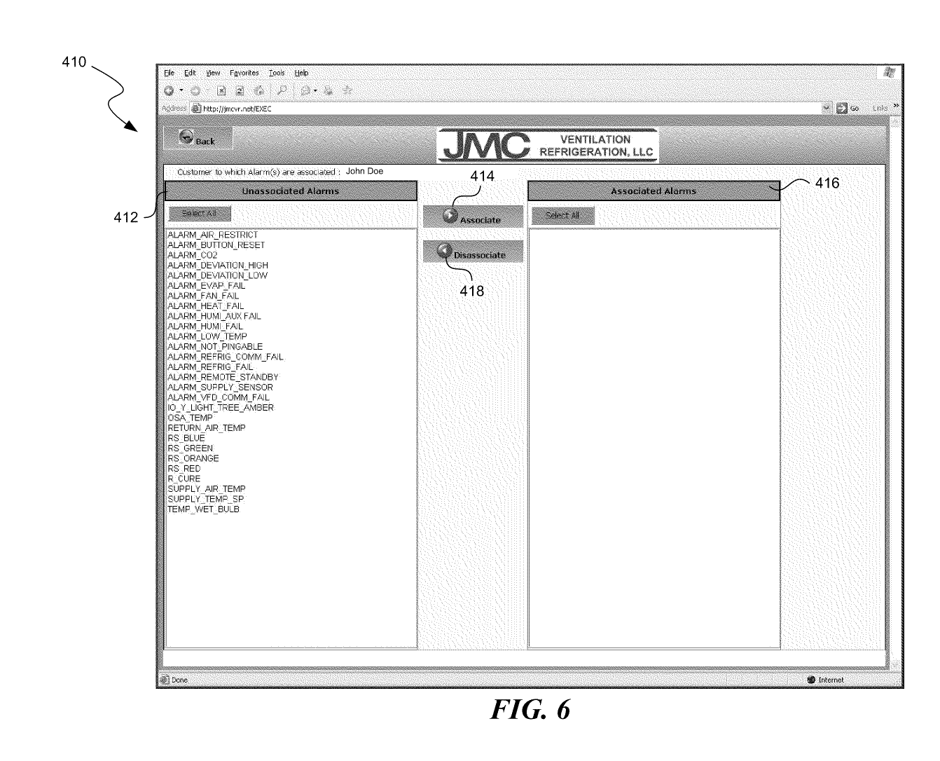

FIG. 5 is a screen shot of a user interface 400 according to several embodiments of the disclosure. As described above, an administrator can grant a user access to information regarding virtually any aspect of a storage facility. The user interface 400 shows the process for granting a user access to storage facility data. Panel 402 lists several storage facilities. The administrator can select any number of these facilities, then click the “associate” button 404 to grant permission to the user, e.g., Jane Doe, to view data for the selected storage facilities which will then appear in the panel 406, labeled “associated storages.” The process can be repeated in reverse to revoke access to the data, using the “disassociate” button 408. FIG. 6 shows a similar user interface 410 in which substantially the same process can be used to associate alarms with a user. Panels 412 and 416, and buttons 414 and 418 can have substantially the same configuration as described with reference to FIG. 3.

An alarm can be triggered by any measurable event. Some examples are failing machinery, temperature limits, humidity levels, etc. The alarm can be delivered to the user through the server 220 and to a device of the user's choosing, including email, SMS messaging, a telephone call, or other method of notification. It is to be appreciated that an alarm may be attached to virtually any event as required by the purpose of the facility and the needs of an operator of the facility.

Several other embodiments and enabling disclosures are included in Appendix A below. Appendix A is included in this specification to further illustrate the scope of the present disclosure. The disclosed embodiments of the invention are not intended to be exhaustive or to limit the invention to the precise form disclosed herein. Specific embodiments of, and examples for, the invention are described above for illustrative purposes, but those skilled in the relevant art will recognize that various equivalent modifications are possible within the scope of the invention. For example, whereas steps are presented in a given order, alternative embodiments may perform steps in a different order. The various aspects of embodiments described herein can be combined and/or eliminated to provide further embodiments. Although advantages associated with certain embodiments of the invention have been described in the context of those embodiments, other embodiments may also exhibit such advantages. Additionally, not all embodiments need necessarily exhibit such advantages to fall within the scope of the invention.

Unless the context clearly requires otherwise, throughout the description and the claims, the words “comprise,” “comprising,” and the like are to be construed in an inclusive sense as opposed to an exclusive or exhaustive sense, i.e., in a sense of “including, but not limited to.” Additionally, the words “herein,” “above,” “below,” and words of similar import, when used in this application, shall refer to this application as a whole and not to any particular portions of this application. Use of the word “or” in reference to a list of items is intended to cover a) any of the items in the list, b) all of the items in the list, and c) any combination of the items in the list.

In general, the terms used in the following claims should not be construed to limit the invention to the specific embodiments disclosed in the specification unless the above-detailed description explicitly defines such terms. In addition, the inventors contemplate various aspects of the invention in any number of claim forms. Accordingly, the inventors reserve the right to add claims after filing the application to pursue such additional claim forms for other aspects of the invention.

We claim:

1. A system for remotely managing produce storage facilities, the system comprising:
a plurality of programmable logic controllers, wherein each programmable logic controller is configured to be located proximate to a corresponding storage facility and operably coupled to one or more pieces of facility equipment, and wherein each programmable logic controller is further configured to gather operating data from the one or more pieces of facility equipment;
a server computer operably coupled to the plurality of programmable logic controllers via a communications link; and
a user computer located remotely from the produce storage facilities, wherein the user computer is configured to access the operating data from the programmable logic controller via the server.

2. A method for remotely managing a plurality of produce storage facilities, the method comprising:
monitoring one or more environmental conditions at each of the plurality of produce storage facilities;
storing data related to the environmental conditions in a database; and
selectively accessing the data via a remote user computer.

3. A system for remotely managing a plurality of produce storage facilities, the system comprising:
means for measuring one or more environmental conditions at each of the plurality of produce storage facilities;
means for recording data related to the environmental conditions; and
means for remotely accessing and displaying the data.
